(19) United States
(12) Patent Application Publication
(10) Pub. No.: US 2024/0318286 A1
(43) Pub. Date: Sep. 26, 2024

(54) cBN SINTERED BODY

(71) Applicant: MITSUBISHI MATERIALS CORPORATION, Tokyo (JP)

(72) Inventor: Masahiro YANO, Naka-shi (JP)

(73) Assignee: MITSUBISHI MATERIALS CORPORATION, Tokyo (JP)

(21) Appl. No.: 18/263,306

(22) PCT Filed: Jan. 24, 2022
(86) PCT No.: PCT/JP2022/002412

§ 371 Date: Jul. 27, 2023

(30) Foreign Application Priority Data
Feb. 2, 2021 (JP) 2021-014845

(51) Int. Cl. C22C 29/16; C22C 29/00

(52) U.S. Cl. CPC C22C 29/16; C22C 29/005

(57) ABSTRACT

A cBN sintered compact comprises: cubic boron nitride grains and a binder phase, wherein
1) the binder phase comprises a Ti—Al alloy containing at least one element selected from the group consisting of Si, Mg, and Zn, and further comprises Ti₂CN and TiB₂;
2) the ratio I_{Ti2CN}/I_{Ti-Al} in XRD is 2.0 or more and 30.0 or less where I_{Ti2CN} represents the peak intensity of Ti₂CN appearing at 2θ angle from 41.9° to 42.2° and I_{Ti-Al} represents the peak intensity of the Ti—Al alloy at 2θ angle from 39.0° to 39.3°;
3) areas where Ti and B elements overlap have an average aspect ratio of 1.7 or more and 6.5 or less and an area rate of 0.025% or more and 0.120% or less, in a mapping image of the Ti and B elements by Auger electron spectroscopy.

### CROSS-REFERENCE TO RELATED PATENT APPLICATIONS

This application is a U.S. National Phase Application under 35 U.S.C. § 371 of International Patent Application No. PCT/JP2022/002412 filed on Jan. 24, 2022 and claims the benefit of priority to Japanese Patent Application No. 2021-014845 filed on Feb. 2, 2021, the contents of all of which are incorporated herein by reference in their entireties. The International Application was published in Japanese on Aug. 11, 2022 as International Publication No. WO/2022/168655 under PCT Article 21(2).

### FIELD OF THE INVENTION

The present invention relates to a cubic boron nitride sintered compact (hereinafter also may be referred to as a cBN sintered compact), which is a hard composite material.

### BACKGROUND OF THE INVENTION

cBN sintered compacts, which are inferior in hardness to diamond, have been used in cutting tools because of low reactivity with Fe-based and Ni-based materials, and have also been used in drilling tips for drilling tools.

Drilling tools are tools used for digging in the ground or rocks. Underground rocks are brittle materials with non-uniformity compositions and strength. Unlike cutting processes, which focus on the performance of cutting and scraping, drilling tools must withstand impacts and vibrations to break rocks, and the rotation to efficiently remove the broken rock pieces. Under these circumstances, several proposals have been made to improve the cutting performance and drilling performance of cemented carbide and cBN sintered compact.

For example, Japanese Patent No. 5804448 discloses a cBN sintered compact that comprises a binder phase containing 45 to 75% by volume of cubic boron nitride grains with an average size of 0.5 to 3.5 μm and titanium boride grains with an average size of 50 to 500 nm dispersed therein, wherein the expression holds: (−0.05X+4.5)<Y<(−0.2X+18) between the content X (% by volume) of the cubic boron nitride grains and the content Y (% by volume) of the formed titanium boride grains, and the proportion of the titanium boride grains not in contact with the cubic boron nitride grains is 15 to 65% by volume of all the titanium boride grains. This cBN sintered compact has excellent toughness and excellent chipping and wear resistance when used in cutting tools.

Japanese Unexamined Patent Application Publication No. Hei 5-310474 discloses a cBN sintered compact that comprises a hard phase comprising 25 to 90% by volume of cubic boron nitride and/or wurtzite boron nitride, and a binder phase being the balance mainly composed of ceramics, where the grains of the hard phase each have a surface including a first layer containing at least one selected from the group consisting of titanium-containing boronitride, borocarbide, boroxide, boronitrooxide, boronitrocarbide, borocarboxide, and boronitrocarboxide, and a second layer over the entire surface of the first layer, the second layer containing at least one selected from the group consisting of aluminum-containing boronitride, borocarbide, boroxide, boronitrooxide, boronitrocarbide, borocarboxide, and boronitrocarbooide. The cBN sintered compact has excellent chipping resistance.

Japanese Unexamined Patent Application Publication No. 2013-537116 discloses a self-sintered polycrystalline cubic boron nitride compact containing a first phase of cBN grains and a ceramic binder phase of a titanium compound, the first phase accounting for more than 80% by volume of the compact. The binder phase is formed of a Ti₂AlC precursor and has conductivity or semiconductivity. As a result, the cBN sintered compact has excellent workability in electric discharge and is suitable for cutting of cast iron and cemented carbide.

### CITATION LIES

### Patent Literature

[PTL 1] Japanese Patent No. 5804448
[PTL 2] Japanese Unexamined Patent Application Publication No. Hei 5-310474
[PTL 3] Japanese Unexamined Patent Application Publication No. 2013-537116

### Technical Problem

The present invention was made in view of the aforementioned circumstances and disclosures. The objective of the present invention is to provide a cBN sintered compact that is a hard composite material having excellent fatigue wear resistance and abrasive wear resistance, and also having resistance to damage such as fracture due to impact and vibration applied to destroy a rock, even when the hard composite material is used as a drilling tool.

### SUMMARY OF THE INVENTION

### Solution to Problem

A cBN sintered compact in accordance with an embodiment of the present invention comprising:
1) cubic boron nitride grains and a binder phase, wherein
2) the binder phase comprises a Ti—Al alloy, Ti₂CN and TiB₂, while the Ti—Al alloy containing at least one element selected from the group consisting of Si, Mg, and Zn;
3) the ratio I_{Ti2CN}/I^{Ti—Al} in XRD is 2.0 or more and 30.0 or less where I_{Ti2CN} represents the peak intensity of Ti₂CN appearing at 2θ from 41.9° to 42.2° and I_{Ti-Al} represents the peak intensity of the Ti—Al alloy at 2θ from 39.0° to 39.3°;
4) areas where Ti and B elements overlap have an average aspect ratio of 1.7 or more and 6.5 or less and an area rate of 0.025% or more and 0.120% or less, in a mapping image of the Ti and B elements by Auger electron spectroscopy.

### Advantageous Effects of Invention

The cBN sintered compact is excellent in fatigue wear resistance and abrasive wear resistance, and has resistance to damage factors such as fracture due to impacts and vibrations for breaking rocks in use as a drilling tool.

### BRIEF DESCRIPTION OF THE DRAWINGS

FIG. 1 is a schematic diagram illustrating overlapping portions of Ti elements and B elements based on elemental mapping by Auger electron spectroscopy in Example 14.

FIG. 2 illustrates elliptical approximation of the overlapping portions in FIG. 1.

### DETAILED DESCRIPTION OF THE INVENTION

The present inventor has investigated to obtain a cBN sintered compact that exhibits excellent fatigue wear resistance and abrasive wear resistance, and has resistance to damage factors, such as fractures due to impacts and vibrations for breaking rocks in use as a drilling tool.

As a result, the inventor has discovered that a sintered compact exhibits excellent fatigue wear resistance and abrasive wear resistance, and has resistant to damage factors, such as fractures due to impacts and vibrations for breaking rocks in use as a drilling tool under the following conditions: a certain relationship holds between XRD peaks of the Ti₂CN and the Ti—Al alloy contained in the binder phase; and areas where Ti elements and B elements overlap have an average aspect ratio within a certain range and an area rate within a certain range.

The following detailed description will focus on application of the cBN compact in accordance with embodiments of the present invention to drilling tools.

The expression “A to B” or “A-B” (A and B are both numerical values) on the numerical range throughout the specification and claims is synonymous with “A or above and B or below”, and the range includes the upper limit value (B) and the lower limit value (A). In the case that only the upper limit (B) is followed by a unit, the unit for the upper limit (B) should also be applied to the lower limit (A).

1. Cubic Boron Nitride (cBN) Grains

The average size of cBN grains and the content of cBN grains in the cBN sintered compact will now be described.

### (1) Mean Grain Size

The cBN grains used in this embodiment may have any mean grain size. The preferred mean grain size ranges from 0.5 to 30.0 μm.

The reason for limiting the range of the mean grain size is as follows: In addition to an improvement in fracture resistance by hard cBN grains contained in the sintered compact, a mean grain diameter of 0.5 to 30.0 μm leads to, for example, not only suppressing in breakage and chipping originating from the uneven shape of the cutting edge caused by detachment of cBN grains from the surface of a drilling tool during use, but also suppressing in cracks propagating from the interface between the cBN grains and the binder phase by stresses applied to the cutting edge of the drilling tool during use or suppressing in propagation of cracking of the cBN grains.

The mean diameter of cBN grains can be determined as follows: The cross section of a sintered cBN is mirror-finished, and the microstructure on the mirror-finished surface is observed by scanning electron microscopy (SEM) to capture a secondary electron image. A portion of cBN grains in the captured image is extracted by image processing, and the mean grain diameter (described below) is calculated based on the maximum length of each grain determined by image analysis.

The extraction of the portions of cBN grains in the image by the image processing comprises the steps of: displaying the image in monochrome of 256 gradations including 0 in black and 255 in white to clearly distinguish the cBN grains from the binder phase; and binarizing the image using a threshold calculated with an expression (w-v)/2+v where v represents the peak pixel value of each portion of cBN grains and w represents the peak pixel value of each portion of the binder phases.

It is preferable to determine pixel values of at least three different cBN particles within the same image area and to define the average of the three pixel values as the peak pixel value of the cBN grain. The region for determining the pixel values of each cBN grain has dimensions of, for example, about 0.5 μm by 0.5 μm. It is preferable to determine pixel values of at least three different bonding-phase grains within the same image area and to define the average of the three pixel values as the peak value of the bonding phase. The region for determining the pixel values of each bonding phase has dimensions of about 0.2 μm by 0.2 μm to 0.5 μm by 0.5 μm.

After the binarization process, the cBN grains are separated from each other by a process that separates the contact portions of the cBN grains, for example, by watershed analysis.

The black portions corresponding to cBN grains in the image after the binarization process are subjected to grain analysis, and the maximum length of each cBN grain is defined as a diameter of the cBN grain. For grain analysis to determine the maximum length, a larger one of the two lengths obtained by calculating the Feret diameter of one cBN grain is a maximum length, and this value is defined as a diameter of each cBN grain.

Each cBN grain is then assumed to be an ideal sphere with this diameter, to calculate the cumulative volume as a volume of the grain. Based on this cumulative volume, a graph is drawn with the vertical axis as volume percentage (%) and the horizontal axis as diameter (μm). The diameter at 50% volume fraction corresponds to the mean diameter of cBN grains. This treatment is performed for three observation areas, and the mean thereof is defined as a mean grain diameter D50 of cBN (μm).

Prior to the grain analysis, a length (μm) per pixel is preliminarily determined with a standard scale in a SEM image. Preferably, at least 30 cBN grains are observed in an observation area. For example, in the case that the average size of the cBN grains is about 3 μm, the observation area is preferably about 15 μm by 15 μm.

### (2) Content

The cBN sintered compact may contain cBN grains in any content (% by volume). In preferred embodiments, the content is within the range between 65% or more and 93.0% or less by volume.

A content below 65.0% by volume leads to a reduced amount of hard material (cBN grains) in the cBN sintered compact, which may result in reduced fracture resistance in use, for example, as a drilling tool. A content above 93.0% by volume leads to formation of voids in the cBN sintered compact, which voids may work as origins of cracks and thus may result in reduced fracture resistance.

The content of the cBN grains in the cBN sintered compact can be determined as follows: A cross-sectional microstructure of the cBN sintered compact is observed by SEM, the portions of cBN grains in the observed secondary electron image are extracted by image processing, and then the area occupied by the cBN grains is calculated by image analysis. This procedure is repeated in at least three observation regions, and the average of the resulting areas is defined as a cBN grain content (% by volume). Preferably, at least 30 cBN grains are observed in an observation area. For example, in the case that the average size of the cBN grains is about 3 μm, the observation area is preferably about 15 μm by 15 μm.

### 2. Binder Phase

The binder phase preferably contains Ti₂CN and TiB₂, in addition to a Ti—Al alloy containing at least one element selected from the group consisting of Si, Mg, and Zn. The term “at least one element” refers to any one, any two, or all three elements of the Si, Mg, and Zn elements.

It is preferable that the XRD peak intensities of Ti₂CN and the Ti—Al alloy contained in the binder phase have a predetermined relation. Specifically, the ratio I_{Ti2CN}/I_{TiAl} of the peak intensities is preferably 2.0 or more and 30.0 or less where I_{Ti2CN} represents the intensity of the Ti₂CN peak appearing at 2θ of 41.9° to 42.2° in XRD and I_{TiAl} represents the intensity of the Ti—Al alloy peak appearing at 2θ of 39.0° to 39.3°. At a ratio of peak intensities within this range, the resulting cBN sintered compact has excellent wear resistance and abrasive wear resistance, and is highly resistant to damage factors such as chipping due to impact and vibration during rock excavation, for the following reasons.

At a ratio I_{Ti2CN}/I_{TiAl} of less than 2.0, an excess amount of Ti—Al alloy present in the cBN sintered compact causes cBN grains to react with the Ti—Al alloy to form coarse TiB₂ and causes an excess amount of AlN to be formed. The TiB₂ and AlN work as starting points for fracture during rock excavation, for example. At a ratio I_{Ti2CN}/I_{TiAl} of greater than 30.0, the content of Ti—Al alloy in the cBN sintered compact decreases, resulting in reductions in adhesion between the cBN particles and the binder phase and toughness of the cBN sintered compact.

The peak intensity I_{Ti2CN} of Ti₂CN and the peak intensity I_{TiAl} of the Ti—Al alloy were determined by XRD using CuKα rays, where the peak of the 111 diffraction line of cBN at 20=43.3 is defined as a standard peak, the peak between 41.9° and 42.2° at 2θ angle is defined as Ti₂CN, and the peak between 39.0° and 39.3° at 2θ angle is defined as Ti—Al alloy. After background noise removal, these peaks are confirmed through peak search.

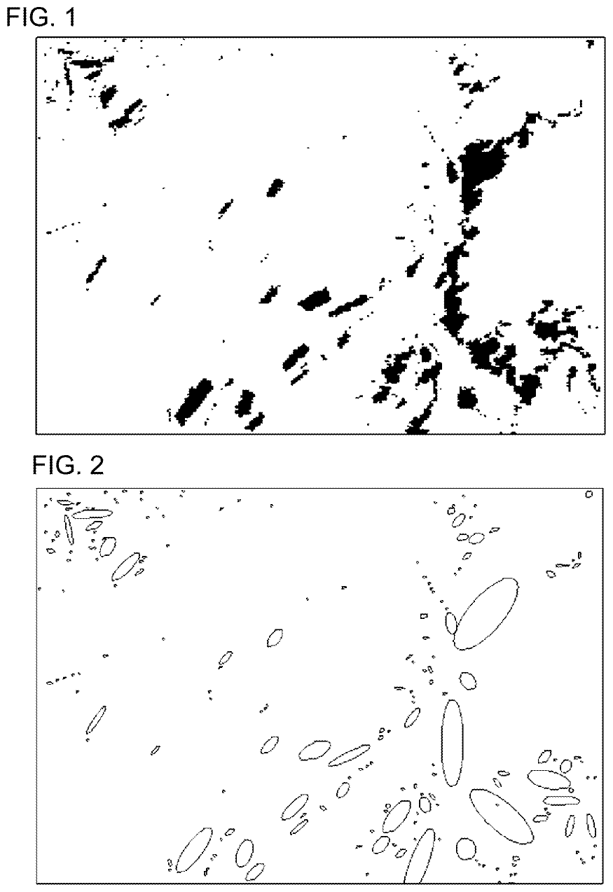

A mapping image of Ti and B elements by Auger Electron Spectroscopy (AES) includes areas where Ti elements and B elements overlap. It is preferred that the overlapping areas each have an aspect ratio of 1.7 or more and 6.5 or less and an area ratio of 0.025% or more and 0.120% or less, in a mapping image of the Ti and B elements. FIG. 1 illustrates the observed results of the sintered compact of Example 14, which will be described later, as example overlapping areas.

The aspect ratio is defined by approximation to ellipses as shown in FIG. 2 of the overlapping areas shown in FIG. 1 by image analysis and averaging the aspect ratios (average ratio of long sides to short sides) of the ellipses, with proviso that overlapping areas having perfect circles with a circularity of 1 are excluded. The average aspect ratio is preferably 1.7 or more and 6.5 or less.

The circularity is defined by 4π×(area)/(perimeter squared), and a perfect circle has a circularity of 1.

The area rate represents the rate of the sum of the overlapping areas other than the areas of regular circles with a circularity of 1 to all the observed areas by the AES, and should preferably be between 0.025% and 0.120% or less for the following reasons:

An average aspect ratio of less than 1.7 cannot sufficiently inhibit the propagation of cracks generated in the cBN sintered compact resulting in an insufficient improvement in the toughness of the cBN sintered compact. An average aspect ratio of greater than 6.5 causes cracks generated in the cBN sintered compact to propagate within the overlapping areas, resulting in an insufficient improvement in the toughness of the cBN sintered compact.

Regarding the area rate of the overlapped area of the Ti and B elements, an area rate of less than 0.025%, regardless of an average aspect ratio within the range of 1.7 to 6.5, cannot sufficiently inhibit the propagation of cracks generated in the cBN sintered compact resulting in an insufficient improvement in the toughness of the cBN sintered compact. An area rate exceeding 0.120% causes the overlapped areas to inhibit the propagation of cracks with high probability, but readily causes the overlapped areas to works as the origins of cracks, in other words, of fatigue fracture.

To calculate the average aspect ratio and area ratio by image analysis, at least three sites in the sintered compact are observed and processed. The observed values at these sites are averaged to determine the average aspect ratio and area ratio. The observation area is preferably about 5.0 μm by 3.5 μm for an average diameter of 3 μm of the cBN grains.

The above description includes the features appended below.

### APPENDIX 1

A cBN sintered compact comprising: cubic boron nitride grains and a binder phase, wherein
1) the binder phase comprises a Ti—Al alloy containing at least one element selected from the group consisting of Si, Mg, and Zn, and further comprises Ti₂CN and TiB₂;
2) the ratio I_{Ti2CN}/I_{Ti-Al} in XRD is 2.0 or more and 30.0 or less where I_{Ti2CN} represents the peak intensity of Ti₂CN appearing at 2θ from 41.9° to 42.2° and I_{Ti-Al} represents the peak intensity of the Ti—Al alloy at 2θ from 39.0° to 39.3°;
3) areas where Ti and B elements overlap have an average aspect ratio of 1.7 or more and 6.5 or less and an area rate of 0.025% or more and 0.120% or less, in a mapping image of the Ti and B elements by Auger electron spectroscopy.

### APPENDIX 2

The cBN sintered compact described in Appendix 1, wherein the cubic boron nitride crystal grains have an average grain size of 0.5 μm or more and 30.0 μm or less.

### APPENDIX 3

The cBN sintered compact described in Appendix 1 or 2, wherein the content of the cubic boron nitride crystal grains is 65% by volume or more and 93.0% by volume or less.

### Examples

Example will now be described; however, the invention should not be construed to limit in any way to these examples applied to tools for cutting rocks.

Example tools were produced by Procedures (1) to (3). The raw powders contained trace amounts of inevitable impurities.

### (1) Preparation of Raw Powder

Hard material, i.e., cBN raw material that had a mean particle size of 0.5 to 35.0 μm after sintering as shown in Table 2, and binder phase material, Ti₂AlC and Ti₃AlC₂ were prepared. Both Ti₂AlC and Ti₃AlC₂ raw powder had a mean particle size of 50 μm.

TiN powder (0.6), TiCN powder (0.6), TiC powder (0.6), TiAl₃ powder (0.4), SiO₂ powder (0.02), ZnO powder (0.8), and MgO powder (0.8) were also prepared as raw powders for formation of the binder phase. The composition of these raw materials is shown in Table 1, where the number in parentheses after the name of each powder is the average particle diameter (D50), in μm.

### (2) Mixing and Presintering Treatment

A ball mill vessel lined with cemented carbide was filled with the prepared powders other than powders containing Si, Mg, or Zn, cemented carbide balls, and acetone, followed by mixing. The mixing time was 1 hr to avoid fine pulverization of the raw powders. It is more preferable to use an ultrasonic agitation device to disintegrate the agglomeration of the raw material powders during mixing, although not used in this example.

The mixed raw powder was then presintering under a vacuum atmosphere of 1 Pa or less at a “Heat treatment temperature after mixing” shown in Table 2 as to evaporate water adsorbed on the powder surface.

The presintering temperature preferably ranges from 250° C. to 900° C. under a vacuum atmosphere of 1 Pa or less for the following reasons: A temperature of less than 250° C. causes insufficient evaporation of adsorbed water and Ti₂AlC and Ti₃AlC₂ to react with residual moisture to be decomposed into TiO₂ and Al₂O₃ during ultrahigh-pressure high-temperature sintering. A temperature exceeding 900° C. causes Ti₂AlC and Ti₃AlC₂ to react with oxygen to be also decomposed into TiO₂ and Al₂O₃ during presintering, resulting in a decrease in the content of Ti₂AlC and Ti₃AlC₂ in the binder phase and a decrease in the toughness of the sintered cBN compact.

A ball mill vessel lined with cemented carbide was filled with powders that did not contain Si, Mg, or Zn elements and had undergone presintering, one or more of the SiO₂, ZnO, and MgO powders, cemented carbide balls, and acetone. The mixing time was one hour to avoid fine pulverization of the raw powders. It is more preferable to use an ultrasonic agitation device to disintegrate the agglomeration of the raw powder during mixing, although not used in this example.

### (3) Compaction and Sintering

Green compacts were produced with the resulting sinter raw material powders, were placed into an ultra-high pressure high-temperature sintering device, and were sintered at a pressure of 5 GPa and a temperature of 1600° C., to yield inventive cBN sintered compacts (example sintered compacts) 1- to 20 shown in Table 2. Each value in Table 2 was measured by the method described above. The average size and content of the cBN grains were determined in an observation area containing at least 30 cBN grains. The other parameters were determined in the observation area described above.

Comparative sintered compacts were also produced for comparison. As raw material for hard material, i.e., cBN raw material that had a mean particle size of 1.0 to 4.0 μm after sintering as shown in Table 4, and binder phase material, Ti₂AlC or Ti₃AlC₂ were prepared. Both Ti₂AlC and Ti₃AlC₂ raw powder had a mean particle size (D50) of 50 μm (the other powders had the same average particle size as that in Examples). These materials were mixed with other powders shown in Tables 1 and 3, except for SiO₂ powder, as in Examples, in a ball mill. Each mixture was presintered at a temperature (“Heat treatment temperature after mixing” in Table 4) in the range of 100° C. to 1200° C. under a vacuum atmosphere of 1 Pa or less, and then was mixed with SiO₂ powder in an amount shown in Tables 1 and 3 under the same condition shown in Examples. The mixture was molded to prepare a green compact. The green compact was placed into an ultra-high pressure high-temperature sintering device, and was sintered at a pressure of 5 GPa and a temperature of 1600° C., to yield comparative cBN sintered compacts (comparative example sintered compacts) 1- to 8 shown in Table 4. Each parameter shown in Table 4 was determined as in Examples.

TABLE 1

| | | Composition (% by volume) | | | | | | | | | | |
|---|---|---|---|---|---|---|---|---|---|---|---|---|
| | | Ti₂AlC | Ti₂AlC | Ti₃AlC₂ | Ti₃AlC₂ | | | | | | | |
| | | (Average | (Average | (Average | (Average | | | | | | | |
| | | grain size: | grain size: | grain size: | grain size: | | | | | | | |
| Type | | 5 μm) | 50 μm) | 5 μm) | 50 μm) | TiN | TiCN | TiC | TiAl₃ | SiO₂ | ZnO | MgO |
| Raw | a | — | — | 5 | 95 | — | — | — | — | — | — | — |
| material | b | — | — | 30 | 68 | — | — | — | — | 2 | — | — |
| of | c | — | — | 6 | 70 | 4 | — | 16 | — | 4 | — | — |
| binder | d | — | — | 17 | 42 | 8 | 30 | — | — | — | — | 3 |
| phae | e | 4 | 71 | 0 | 20 | — | — | — | — | 5 | — | — |
| for | f | 5 | 95 | — | — | — | — | — | — | — | — | — |
| Example* | g | 24 | 52 | — | — | 20 | — | — | — | 4 | — | — |
| | h | 2 | 74 | — | — | — | — | — | 20 | 4 | — | — |
| | i | 2 | 54 | — | — | 15 | — | 15 | — | 5 | 5 | — |
| | j | 30 | 45 | — | — | — | 20 | — | 5 | — | — | — |
| | k | 2 | 58 | — | — | — | 38 | — | — | 2 | — | — |
| | l | 22 | 38 | — | — | — | 38 | — | — | — | — | 2 |

In Table 1, the symbol “—” indicates that it is not compounded, and the symbol “*” indicates that some of the binder phase materials were also used in comparative examples.

TABLE 2

| | | | | | | | | Average | |
|---|---|---|---|---|---|---|---|---|---|
| | | | | | Heat | Ratio | | aspect | |
| | | cBN | | Material | tratment | of peak | | ratio of | |
| | | Content | Average | for | temperature | intensities | Area | overlapping | |
| | | (% by | grain size | binder | after mixing | by XRD | rate | Ti and | Composition of sintered compact |
| Type | | volume) | (μm) | phase | (° C.) | [_{Ti2CN}/[_{Ti—Al} | (%) | B elements | (identified by XRD) |
| Sintered | 1 | 71.2 | 30.0 | e | 600 | 11.6 | 0.080 | 2.5 | cBN, Ti₂CN, TiB₂, TiAl₃, AlN |
| compact | | | | | | | | | (Al₂O₃ peak not found*) |
| of | 2 | 75.6 | 3.7 | d | 600 | 10.1 | 0.037 | 6.2 | cBN, Ti₂CN, TiB₂, TiAl₃, AlN |
| example | | | | | | | | | (Al₂O₃ peak not found*) |
| | 3 | 72.1 | 20.9 | a | 800 | 9.3 | 0.120 | 2.7 | cBN, Ti₂CN, TiB₂, TiAl₃, AlN |
| | | | | | | | | | (Al₂O₃ peak not found*) |
| | 4 | 73.4 | 7.9 | g | 600 | 19.2 | 0.061 | 5.2 | cBN, Ti₂CN, TiC, TiB₂, TiAl₃, Al₂O₃, AlN |
| | 5 | 74.2 | 2.5 | h | 600 | 6.1 | 0.090 | 1.9 | cBN, Ti₂CN, TiB₂, TiAl₃, Al₂O₃, AlN |
| | 6 | 76.1 | 3.9 | i | 600 | 13.1 | 0.037 | 1.9 | cBN, Ti₂CN, TiB₂, TiAl₃, Al₂O₃, AlN |
| | 7 | 91.5 | 2.2 | f | 600 | 10.6 | 0.059 | 2.6 | cBN, Ti₂CN, TiB₂, TiAl₃, Al₂O₃, AlN |
| | 8 | 75.0 | 2.3 | j | 600 | 14.1 | 0.105 | 6.5 | cBN, Ti₂CN, TiB₂, TiAl₃, Al₂O₃, AlN |
| | 9 | 73.4 | 2.8 | e | 600 | 11.1 | 0.089 | 2.3 | cBN, Ti₂CN, TiB₂, TiAl₃, AlN |
| | | | | | | | | | (Al₂O₃ peak not found*) |
| | 10 | 75.9 | 2.4 | f | 600 | 10.7 | 0.077 | 2.4 | cBN, Ti₂CN, TiB₂, TiAl₃, Al₂O₃, AlN |
| | 11 | 75.0 | 2.8 | k | 600 | 25.5 | 0.034 | 2.5 | cBN, Ti₂CN, TiB₂, TiAl₃, Al₂O₃, AlN |
| | 12 | 75.4 | 2.7 | l | 400 | 30.0 | 0.025 | 6.0 | cBN, Ti₂CN, TiB₂, TiAl₃, Al₂O₃, AlN |
| | 13 | 75.6 | 3.2 | h | 250 | 2.0 | 0.094 | 1.7 | cBN, Ti₂CN, TiB₂, TiAl₃, Al₂O₃, AlN |
| | 14 | 74.1 | 14.7 | f | 900 | 9.9 | 0.081 | 2.6 | cBN, Ti₂CN, TiB₂, TiAl₃, Al₂O₃, AlN |
| | 15 | 74.5 | 4.2 | b | 800 | 8.9 | 0.119 | 6.4 | cBN, Ti₂CN, TiB₂, TiAl₃, AlN |
| | | | | | | | | | (Al₂O₃ peak not found*) |
| | 16 | 69.7 | 1.4 | h | 300 | 3.3 | 0.108 | 1.8 | cBN, Ti₂CN, TiB₂, TiAl₃, Al₂O₃, AlN |
| | 17 | 86.4 | 2.9 | f | 600 | 9.8 | 0.064 | 2.6 | cBN, Ti₂CN, TiB₂, TiAl₃, Al₂O₃, AlN |
| | 18 | 75.7 | 2.8 | a | 600 | 11.1 | 0.116 | 2.9 | cBN, Ti₂CN, TiB₂, TiAl₃, AlN |
| | | | | | | | | | (Al₂O₃ peak not found*) |
| | 19 | 74.3 | 0.5 | c | 800 | 13.2 | 0.062 | 3.6 | cBN, Ti₂CN, TiB₂, TiAl₃, AlN |
| | | | | | | | | | (Al₂O₃ peak not found*) |
| | 20 | 73.9 | 2.5 | l | 900 | 22.2 | 0.030 | 5.9 | cBN, Ti₂CN, TiB₂, TiAl₃, Al₂O₃, AlN |

In Table 2, the symbol “*” indicates that the Al₂O₃ was observed by electron probe micro analyzer (EPMA).

TABLE 3

| | | Composition (% by volume) | | | | | | |
|---|---|---|---|---|---|---|---|---|
| | | Ti₂AlC | Ti₂AlC | Ti₃AlC₂ | Ti₃AlC₂ | | | |
| | | (Average | (Average | (Average | (Average | | | |
| | | grain size: | grain size: | grain size: | grain size: | | | |
| Type | | 5 [symbol] | 50 μm) | 5 [symbol] | 50 μm) | TiCN | TiAl₃ | SiO₂ |
| Raw | m | 1 | 4 | — | — | 55 | 37 | 3 |
| material | n | 40 | 20 | — | — | 38 | — | 2 |
| of binder | o | — | — | 1 | 39 | 55 | 5 | — |
| phae for | p | — | — | 2 | 38 | — | 57 | 3 |
| Comparative | q | — | — | 40 | 55 | — | — | — |
| example | r | 2 | 38 | — | — | — | 57 | 3 |

In Table 3, the symbol “—” indicates that it is not compounded [symbol] [symbol]
indicates data missing or illegible when filed

TABLE 4

| | | | | | | | | Average | |
|---|---|---|---|---|---|---|---|---|---|
| | | cBN | | | Heat | Ratio | | aspect | |
| | | | Average | Material | treatment | of peak | | ratio of | |
| | | Content | grain | for | temperature | intensities | Area | over lapping | |
| | | (% by | size | binder | after mixing | by XRD | rate | Ti and | Composition of sintered compact |
| Type | | volume) | (μm) | phase | (° C.) | [_{Ti2CN}/[_{Ti—Al} | (%) | B elements | (identified by XRD) |
| Sintered | 1 | 73.7 | 2.8 | e | 1200 | —* ¹ | 0.072 | 2.0 | cBN, Ti₂CN, TiB₂, TiAl₃, AlN |
| compact of | | | | | | | | | (Al₂O₃ peak not found*²) |
| comparative | 2 | 72.6 | 1.9 | q | 650 | 9.4 | 0.205 | 10.8 | cBN, Ti₂CN, TiB₂, TiAl₃. AlN |
| example | | | | | | | | | (Al₂O₃ peak not found*²) |
| | 3 | 74.1 | 2.4 | o | 100 | 45.6 | 0.030 | 1.9 | cBN, Ti₂CN, TiB₂, TiAl₃, AlN |
| | | | | | | | | | (Al₂O₃ peak not found*²) |
| | 4 | 73.9 | 2.6 | p | 600 | 0.6 | 0.032 | 2.6 | cBN, Ti₂CN, TiB₂, TiAl₃, Al₂O₃, AlN |
| | 5 | 73.1 | 2.1 | n | 900 | 18.4 | 0.040 | 11.2 | cBN, Ti₂CN, TiB₂, TiAl₃, Al₂O₃, AlN |
| | 6 | 74.4 | 2.7 | r | 600 | 0.5 | 0.020 | 2.4 | cBN, Ti₂CN, TiB₂, TiAl₃, Al₂O₃, AlN |
| | 7 | 75.5 | 2.4 | o | 600 | 60.8 | 0.033 | 1.7 | cBN, Ti₂CN, TiB₂, TiAl₃, AlN |
| | | | | | | | | | (Al₂O₃ peak not found*²) |
| | 8 | 73.9 | 2.8 | m | 600 | 14.7 | 0.014 | 1.2 | cBN, Ti₂CN, TiB₂, TiAl₃, Al₂O₃, AlN |

In Table 4, the symbol * ¹″ indicates that the TiAl₃ was not observed by XRD, and the symbol “*²” indicates that Al₂O₃ was observed by electron probe micro analyzer (EPMA).

Example tools 1 to 20 (referred to as Examples 1 to 20) and Comparative tools 1 to 8 (referred to as Comparative Examples 1 to 8) having ISO standard RNGN090300 geometry were fabricated from Inventive sintered compacts 1 to 15 and Comparative sintered compacts 1 to 5, respectively, and were each mounted on an NC lathe for the following wet cutting tests.
Cutting speed: 150 m/min
Depth of cut: 0.3 mm
Feed rate: 0.1 mm/rev
Workpiece material to be cut: granite (from Takine) Shape Φ150 mm by 200 mm L
Cutting fluid material: water-soluble cutting oil (Neocool by MORESCO Co., Ltd.)

The amount of wear of the cutting edge and the state of the cutting edge were checked after the cutting length (cutting distance) reached 800 m. Regardless of this, the cutting edge was observed every 100 m of cutting length to observe any defect and the amount of wear. If the amount of wear exceeded 2000 μm, the cutting test was stopped at that point. The results are shown in Table 5.

TABLE 5

| Type | | Amount of wear (State of edge) | Type | | Amount of wear (State of edge) |
|---|---|---|---|---|---|
| Example | 1 | 390 μm (Chipping not observed | Comparative | 1 | Not measured (Fracture)* |
| | 2 | 1870 μm (Chipping observed) | example | 2 | Not measured (Fracture)* |
| | 3 | 1920 μm (Chipping observed) | | 3 | 2450 μm (Chipping observed)* |
| | 4 | 590 μm (Chipping not observed | | 4 | 2600 μm (Chipping observed)* |
| | 5 | 610 μm (Chipping not observed | | 5 | Not measured (Fracture)* |
| | 6 | 710 μm (Chipping not observed | | 6 | 2350 μm (Chipping observed)* |
| | 7 | 370 μm (Chipping not observed | | 7 | Not measured (Fracture)* |
| | 8 | 1920 μm (Chipping observed) | | 8 | 2400 μm (Chipping observed)* |
| | 9 | 700 μm (Chipping not observed | | | |
| | 10 | 550 μm (Chipping not observed | | | |
| | 11 | 140 μm (Chipping not observed | | | |
| | 12 | 1980 μm (Chipping observed) | | | |
| | 13 | 910 μm (Chipping not observed | | | |
| | 14 | 400 μm (Chipping not observed | | | |
| | 15 | 2020 μm (Chipping observed) | | | |
| | 16 | 2230 μm (Chipping observed) | | | |
| | 17 | 450 μm (Chipping not observed | | | |
| | 18 | 810 μm (Chipping not observed | | | |
| | 19 | 470 μm (Chipping not observed | | | |
| | 20 | 1860 μm (Chipping observed) | | | |

In Table 5, the symbol “*” indicates the state at a cutting length of 100 m.

Table 5 evidentially demonstrates that all Examples show reduced amount of wear and no chipping indicating high abrasive wear resistance, and also are resistant to damage factors, such as fracture due to impacts and vibrations to destroy rocks, even use as drilling tools. In contrast, all Comparative examples experience fracture or a high amount of wear after only a short cutting length, and thus have low abrasion resistance, which results indicate that they are difficult to use as drilling tools.

The disclosed embodiments are illustrative only and not restrictive in all respects. The scope of the invention is indicated by the claims rather than the aforementioned embodiments and is intended to include all modifications within the gist and scope of the claims and equivalents.

1. A cBN sintered compact comprising:
cubic boron nitride grains; and
a binder phase, wherein
1) the binder phase comprises;
a Ti—Al alloy,
Ti₂CN, and
TiB₂,
The Ti—Al alloy containing at least one element selected from the group consisting of Si, Mg, and Zn,
2) a ratio I_{Ti2CN}/I_{Ti-Al} in XRD is 2.0 or more and 30.0 or less, where I_{Ti2CN} represents the peak intensity of Ti₂CN appearing at 2θ from 41.9° to 42.2° and I_{Ti-Al} represents the peak intensity of the Ti—Al alloy at 2θ angle from 39.0° to 39.3°, and
3) areas where Ti and B elements overlap have an average aspect ratio of 1.7 or more and 6.5 or less and an area rate of 0.025% or more and 0.120% or less, in a mapping image of the Ti and B elements by Auger electron spectroscopy.
